(19) United States
(12) Patent Application Publication
(10) Pub. No.: US 2025/0388062 A1
(43) Pub. Date: Dec. 25, 2025

(54) RV AC-Unit Condensation Collection Device

(71) Applicant: Andrew Page, Porter, TX (US)

(72) Inventor: Andrew Page, Porter, TX (US)

(21) Appl. No.: 18/955,233

(22) Filed: Nov. 21, 2024

Related U.S. Application Data
(60) Provisional application No. 63/661,935, filed on Jun. 20, 2024.

(51) Int. Cl. B60H 1/32; B60H 1/00

(52) U.S. Cl. CPC B60H 1/3233; B60H 1/00364

(57) ABSTRACT

An RV AC-unit condensation collection device is provided. The device comprises a body made of plastic or corrosion-resistant metal, which features a central recessed area to gather condensation. The recessed area may include a beveled edge and at least one overflow channel for efficient condensation management. To ensure stability, the bottom surface of the body is designed with a non-slip material and may include fasteners like suction cups or adhesives. A male member with an opening connects to the recessed area and facilitates the drainage of collected condensation through a hose, which attaches using fasteners and reciprocating connectors. The method of using the device involves placing the body near the AC-unit to collect condensation, attaching the hose to the male member, and routing the hose to a designated drainage location.

### CROSS-REFERENCE TO RELATED APPLICATION

The present application claims priority to, and the benefit of, U.S. Provisional Application No. 63/661,935, which was filed on Jun. 20, 2024, and is incorporated herein by reference in its entirety

### FIELD OF THE INVENTION

The present invention relates generally to the field of RV AC-units. More specifically, the present invention relates to a device for catching and re-routing condensation from an RV AC-unit. Accordingly, the present disclosure makes specific reference thereto. Nonetheless, it is to be appreciated that aspects of the present invention are also equally applicable to other like applications, devices, and methods of manufacture.

### BACKGROUND

Recreational vehicle (RV) roofs are particularly vulnerable to wear and damage, primarily due to the buildup of condensation that tends to accumulate and drain across the surface. This issue is often exacerbated by the air conditioning units installed on RVs, which release condensation as a byproduct of their cooling processes. Over time, the water runoff from these units can lead to persistent damp spots on the roof, creating ideal conditions for the growth of mold and mildew. This growth not only threatens the structural integrity of the roof but also poses potential health risks to those inside the RV.

Moreover, addressing this issue through regular cleaning of the RV roof can be a significant challenge. The process is time-consuming and physically demanding, requiring the individual to navigate the slippery and uneven surface of the roof. The presence of condensation makes the surface especially slick, increasing the risk of slips and falls. The danger of working at a height on a wet and unstable surface means that cleaning an RV roof can become a hazardous task, requiring both caution and the use of specialized safety equipment. As a result, many RV owners find themselves struggling with the balance between maintaining their roofs in good condition and ensuring their own safety during the cleaning process.

Therefore, there exists a long-felt need in the art for a device for mitigating condensation collection on an RV roof. There also exists a long-felt need in the art for an RV AC-unit condensation collection device. More specifically, there exists a long-felt need in the art for an RV AC-unit condensation collection device that collects condensation from an RV AC-unit. In addition, there exists a long-felt need in the art for an RV AC-unit condensation collection device that collects condensation from an RV AC-unit, wherein the device re-routes the condensation away from the roof.

The subject matter disclosed and claimed herein, in one embodiment thereof, comprises an RV AC-unit condensation collection device. The device comprises a body made of plastic or corrosion-resistant metal, which features a central recessed area to gather condensation. The recessed area may include a beveled edge and at least one overflow channel for efficient condensation management. To ensure stability, the bottom surface of the body is designed with a non-slip material and may include fasteners like suction cups or adhesives. A male member with an opening connects to the recessed area and facilitates the drainage of collected condensation through a hose, which attaches using fasteners and reciprocating connectors. The method of using the device involves placing the body near the AC-unit to collect condensation, attaching the hose to the male member, and routing the hose to a designated drainage location.

In this manner, the RV AC-unit condensation collection device of the present invention accomplishes all the forgoing objectives and provides a device for mitigating condensation collection on an RV roof. More specifically, the device collects condensation from an RV AC-unit. In addition, the device re-routes the condensation away from the roof via the hose once collected.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an RV AC-unit condensation collection device. The device is comprised of a plastic or corrosion-resistant metal body, which may have any shape with at least one central recessed area. The recessed area is designed to collect condensation from an RV AC unit when positioned accordingly. The recessed area may include a beveled outer edge, and the body may have at least one overflow channel. The bottom surface of the body is comprised of a non-slip material, such as rubber with a textured surface, to prevent movement. In some embodiments, the bottom surface may include at least one fastener, such as a suction cup, adhesive, or magnet fastener, for securing the device.

The body includes at least one male member with an opening, allowing fluid communication between the recessed area and the male member, enabling drainage of the collected condensation. The male member is further equipped with a fastener for attachment to a hose through a reciprocating connector. The fastener and connector can be any compatible types, such as threaded or quick connectors. In some embodiments, the hose is Y-shaped with multiple connectors, allowing connection to multiple bodies.

The method of using the device includes the following steps: providing the device with a body comprising a recessed area, a male member with an opening and fastener, and a hose with a connector; positioning the body under or near an RV AC unit to collect condensation within the recessed area; connecting the hose to the male member using the fastener and connector; and routing the hose to a secondary location for draining the collected condensation.

Accordingly, the RV AC-unit condensation collection device of the present invention is particularly advantageous as it provides a device for mitigating condensation collection on an RV roof. More specifically, the device collects condensation from an RV AC-unit. In addition, the device re-routes the condensation away from the roof via the hose once collected. In this manner, the RV AC-unit condensation collection device provides a solution to manage RV AC-unit condensation.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which

FIG. 1 illustrates a perspective view of one potential embodiment of an RV AC-unit condensation collection device of the present invention in accordance with the disclosed architecture;

FIG. 2 illustrates a perspective view of one potential embodiment of an RV AC-unit condensation collection device of the present invention in accordance with the disclosed architecture;

FIG. 3 illustrates a perspective view of one potential embodiment of an RV AC-unit condensation collection device of the present invention in accordance with the disclosed architecture; and

FIG. 4 illustrates a flowchart of a method of using one potential embodiment of an RV AC-unit condensation collection device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for mitigating condensation collection on an RV roof. There also exists a long-felt need in the art for an RV AC-unit condensation collection device. More specifically, there exists a long-felt need in the art for an RV AC-unit condensation collection device that collects condensation from an RV AC-unit. In addition, there exists a long-felt need in the art for an RV AC-unit condensation collection device that collects condensation from an RV AC-unit, wherein the device re-routes the condensation away from the roof.

The present invention, in one exemplary embodiment, is comprised of an RV AC-unit condensation collection device. The device features a body made of plastic or corrosion-resistant metal, adaptable to various shapes with at least one central recessed area. This recessed area is designed to capture condensation from an RV AC unit when positioned appropriately. It may include a beveled outer edge, and the body can have at least one overflow channel. The bottom surface of the body is equipped with a non-slip material, such as rubber with a textured finish, to prevent shifting. In certain embodiments, the bottom surface may also include at least one fastener, such as a suction cup, adhesive, or magnetic fastener, to secure the device.

The body contains at least one male member with an opening, facilitating fluid flow between the recessed area and the male member for draining the collected condensation. The male member is fitted with a fastener for connecting to a hose via a compatible connector. The fastener and connector can include types such as threaded or quick connectors. In some versions, the hose is Y-shaped with multiple connectors, allowing attachment to several bodies.

The method for using the device involves providing it with a body that includes a recessed area, a male member with an opening and fastener, and a hose with a connector; positioning the body beneath or near an RV AC unit to gather condensation in the recessed area; attaching the hose to the male member using the fastener and connector; and routing the hose to a secondary location for condensation drainage.

The RV AC-unit condensation collection device is particularly beneficial for managing condensation on an RV roof. It effectively gathers condensation from the RV AC unit and directs it away from the roof through the hose. This design provides an effective solution for controlling RV AC-unit condensation.

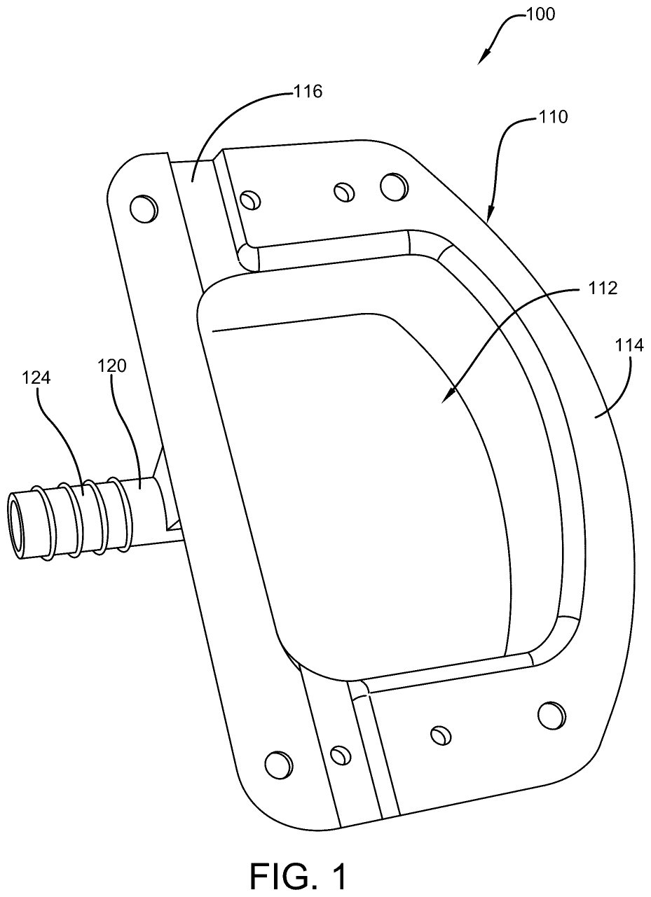

Referring initially to the drawings, FIG. 1 illustrates a perspective view of one potential embodiment of an RV AC-unit condensation collection device 100 of the present invention in accordance with the disclosed architecture. The device 100 is preferably comprised of a plastic or corrosion-resistant metal. The body 110 of the device 100 may be any shape with at least one central recessed area 112. The recessed area 112 collects condensation dripping from an RV AC-unit once the device 100 is positioned under/near the AC-unit accordingly to catch condensation. The recessed area 112 may be comprised of a beveled outer edge 114 in one embodiment. The body 110 may also be comprised of at least one overflow channel 116. A bottom surface 118 of the body 110 may be comprised of a non-slip material, such as but not limited to a rubber with a raised and/or recessed texture, in order to prevent movement of the device 100. In one embodiment, the bottom surface 118 is comprised of at least one fastener 119 to secure the device 100 during use. The fastener 119 may be any fastener type such as but not limited to a suction cup fastener, an adhesive fastener, a magnet fastener, etc.

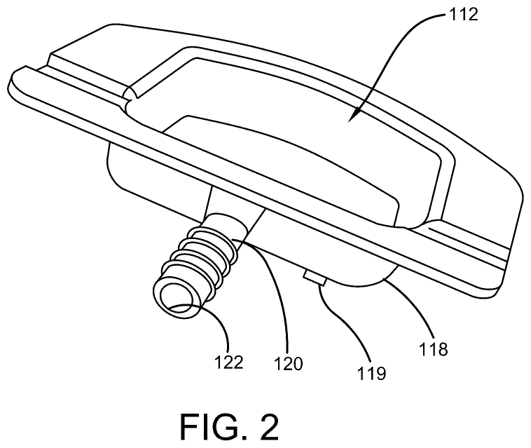

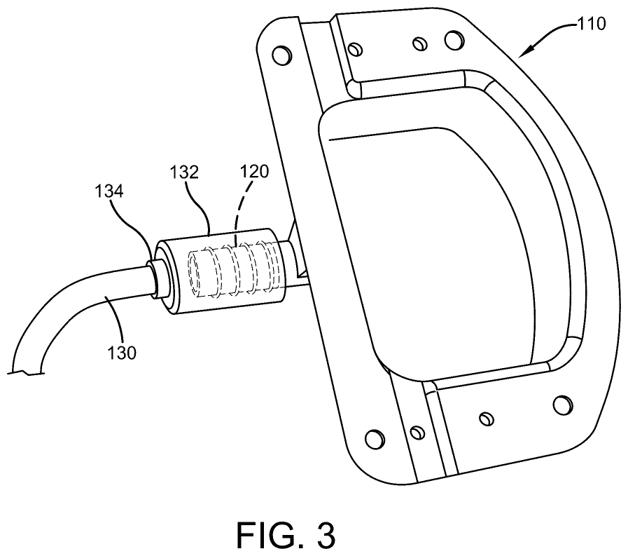

The body 110 is further comprised of at least one male member 120 with at least one opening 122 (as seen in FIG. 2) that places the male member 120 in fluid communication with the recessed area 112. As a result, condensation collected within the recessed area 112 can drain out of the body 110 via the member 120. More specifically, the member 120 is comprised of at least one fastener 124 that allows the member 120 to attach to a hose 130 via at least one reciprocating connector 132 of the hose 130, as seen in FIG. 3. The fastener 124 and connector 132 may be any reciprocating fastener types such as but not limited to a male and female thread, a pair of quick connectors, a pair of hose connectors. In one embodiment, the hose 130 is comprised of a Y-shaped hose with multiple connectors 132 to attach to multiple bodies 110.

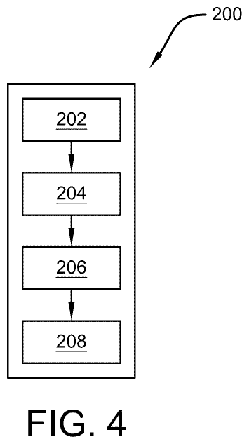

The present invention is also comprised of a method of using 200 the device 100, as seen in FIG. 4. First, a device 100 is provided comprised of a body 110 comprised of a recessed area 112, a male member 120 comprised of an opening 122 and a fastener 124, and a hose 130 comprised of a connector 132 [Step 202]. Then, the body 110 can be positioned under or near an RV AC-unit to collect a condensation from the unit within the recessed area 112 [Step 204]. Then, the hose 130 can be connected to the male member 120 via the fastener 124 and connector 132 [Step 206]. Finally, the hose 130 can be routed to a secondary location to drain the condensation collected within the recessed area 112 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “RV AC-unit condensation collection device” and “device” are interchangeable and refer to the RV AC-unit condensation collection device 100 of the present invention.

Notwithstanding the forgoing, the RV AC-unit condensation collection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the RV AC-unit condensation collection device 100 as shown in the FIGS. are for illustrative purposes only, and that many other sizes and shapes of the RV AC-unit condensation collection device 100 are well within the scope of the present disclosure. Although the dimensions of the RV AC-unit condensation collection device 100 are important design parameters for user convenience, the RV AC-unit condensation collection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An RV AC-unit condensation collection device comprising:
a body comprising a recessed area and a bottom surface comprising a non-slip material;
a male member extending from the body, the male member comprising an opening in fluid communication with the recessed area; and
a first fastener coupled to the male member configured to attach to a hose via a connector of the hose.

2. The RV AC-unit condensation collection device of claim 1, wherein the recessed area is comprised of a beveled outer edge.

3. The RV AC-unit condensation collection device of claim 1, wherein the non-slip material is comprised of a rubber material.

4. The RV AC-unit condensation collection device of claim 1, wherein the rubber material is comprised of a raised texture.

5. The RV AC-unit condensation collection device of claim 4, wherein the rubber material is comprised of a recessed texture.

6. The RV AC-unit condensation collection device of claim 1, wherein the bottom surface is comprised of a second fastener.

7. The RV AC-unit condensation collection device of claim 1, wherein the second fastener is comprised of a suction cup, an adhesive, or a magnet.

8. The RV AC-unit condensation collection device of claim 1, wherein the first fastener is comprised of a thread.

9. The RV AC-unit condensation collection device of claim 1, wherein the first fastener and the connector are comprised of a pair of reciprocating fasteners.

10. An RV AC-unit condensation collection device comprising:
a body comprising a central recessed area and an overflow channel;
a male member attached to the body and having an opening in fluid communication with the central recessed area;
a hose having a connector configured to attach to the male member;
a fastener coupled to the male member to facilitate attachment of the hose; and
a bottom surface of the body comprising a non-slip material.

11. The RV AC-unit condensation collection device of claim 10, wherein the body is comprised of a plastic material.

12. The RV AC-unit condensation collection device of claim 10, wherein the body is comprised of a corrosion-resistant metal material.

13. The RV AC-unit condensation collection device of claim 10 further comprised of a shutoff valve.

14. The RV AC-unit condensation collection device of claim 10, wherein the hose is comprised of a Y-shaped hose.

15. The RV AC-unit condensation collection device of claim 13, wherein the shutoff valve is positioned on the connector.

16. A method of using an RV AC-unit condensation collection device, the method comprising the following steps:
providing a device comprising a body with a central recessed area, a male member with an opening, and a fastener coupled to the male member;
positioning the body under or near an RV AC-unit such that the recessed area collects a condensation dripping from the RV AC-unit;
attaching a hose to the male member using the fastener; and
routing the hose to a secondary location to drain the condensation collected within the recessed area.

17. The method of using an RV AC-unit condensation collection device of claim 16, wherein the body is comprised of a fastener.

18. The method of using an RV AC-unit condensation collection device of claim 16, wherein the body is comprised of a non-slip bottom surface.

19. The method of using an RV AC-unit condensation collection device of claim 16, wherein the hose is comprised of a Y-shaped hose.

20. The method of using an RV AC-unit condensation collection device of claim 16, wherein the hose is comprised of a connector.
